(19) United States
(12) Patent Application Publication
(10) Pub. No.: US 2006/0261599 A1
(43) Pub. Date: Nov. 23, 2006

(54) Cover lock mechanism

(76) Inventor: Takayuki Ikemoto, Tokyo (JP)

Correspondence Address: BUCHANAN, INGERSOLL & ROONEY PC, POST OFFICE BOX 1404, ALEXANDRIA, VA, 22313-1404, US

(21) Appl. No.: 10/568,459

(22) PCT Filed: Jul. 8, 2004
(86) PCT No.: PCT/JP04/09738

§ 371 Date: Feb. 15, 2006

(51) Int. Cl. E05C 19/10

(52) U.S. Cl. 292/121

(57) ABSTRACT

A cover of a housing for containing various control devices mounted under the floor of a vehicle can be opened by itself due to vibration during traveling of the vehicle, in the case of forgetting to lock the cover or improper locking, resulting in possible danger. A latch is held by a leaf spring that is mounted on the backside of the cover and the latch is biased from a center of an opening of the housing toward a periphery thereof. When the cover is opened, a hook formed at the latch is hooked on a periphery of the opening by bias force from the leaf spring, thus preventing the cover from being opened further. By inserting a finger through a slightly open gap to release the hook, the cover can be opened easily.

### TECHNICAL FIELD

The present invention relates to a lock mechanism of a cover mounted via a hinge onto a housing body that contains, e.g., electronic devices therein.

### BACKGROUND ART

Various electronic devices or pneumatic/hydraulic control devices are mounted onto moving bodies such as trains or automobiles. These various control devices may be mounted in an internal part of the automobile, or may be mounted under floor or on roof. Many of these varieties of control devices are extremely important devices for safety reasons of a moving body. Accordingly, wherever these control devices are located, it is necessary to put them in an internal part of a housing provided with a cover in order to protect the mentioned control devices from wind, rain, snow, or dust. A variety of housings provided with covers intended to meet such requirements have been proposed.

A housing provided with such a cover generally adopts a construction of fully closing a cover 2 by locking the cover 2 having been closed with a pawl 5a equipped with a handle 5 as shown, for example, in an external appearance view of FIG. 9 and a cross sectional view of FIG. 10.

This construction is such that the cover 2 is mounted onto a hinge 3 that is attached to a housing body 1, whereby the cover makes an opening 10 of the housing body open and closed with the hinge 3 acting as a fulcrum, and such that a pawl 5a is turned along with the handle 5 being turned when closing the cover 2, and is hooked on an edge of the opening of the housing 1.

However, with such a construction, there is a disadvantage such that the cover 2 may be opened while the vehicle is traveling, for example, in the case where a maintenance worker forgets to lock or it is in the state of improper locking after the maintenance inspection of devices in an internal part of the housing. With reference to FIG. 10, the hinge 3 is located on the upper side (this is hereinafter referred to as upper-hinged type for reasons of description), and the cover 2 is closed by itself under its weight and can be opened only by lifting it up by manpower in the case of opening. In the case where the hinge 3 is located on the lower side (this is referred to as lower-hinged type, not shown) and the cover 2 is opened downward, the cover may be opened suddenly under weight of the cover at the moment when the pawl 5a is released, resulting in a further problem of being dangerous in the case of a heavy cover 2. As means of solution to such problems, a device disclosed in Patent Document 1 was proposed.

The device disclosed in Patent Document 1 is constructed such that a rod stay (20) that is attached to a door is hooked on a pin (22) that is formed on the housing side under weight of the stay itself when a door (12) is opened, whereby the door (12) is held at a predetermined angle.

However, the construction disclosed in Patent Document 1 cannot be applied to the one of upper-hinged type or left-hand/right-hand type (because the stay cannot be hooked under its own weight).

Patent Document 1: the Japanese Patent Publication (unexamined) No. 173513/1994 “Stay”, FIG. 1

### DISCLOSURE OF INVENTION

### Problems to be Solved by the Invention

A problem exists in that the cover 2 may be opened while the vehicle is traveling in the case of forgetting to lock, or being in the state of improper locking after the maintenance inspection of devices in an internal part of the housing. Furthermore, another one is proposed in that a rod stay that is attached to a door is hooked on a pin that is formed on the housing side under weight of the stay itself when the door is opened, whereby the door is held at a predetermined angle. However, a further problem exits in that this construction cannot be applied to the one of upper-hinged type or left-hand/right-hand type.

The present invention was made to solve each of the conventional problems as described above at the same time, and has an object of providing a lock mechanism that can be employed without regard to which direction a cover is opened in, and that prevents the cover from being opened at not less than an arbitrary angle even in the case where an operator fails to do lock operation.

A cover lock mechanism according to the present invention is mounted onto a cover that is attached rotatably with a hinge, which is fixed to a housing mounted on, e.g., a vehicle, and that makes an opening of this housing open and closed; and prevents the cover from being fully opened accidentally. This cover lock mechanism comprises a latch that is held while being biased from a center of the mentioned opening toward a periphery of the mentioned opening by means of a leaf spring mounted onto a side of the cover being in contact with the mentioned opening, that can move along a direction of connecting an arbitrary point on a periphery of the mentioned opening and a center of mentioned opening, and that includes a hook, which is hooked on an arbitrary point of the periphery of the mentioned opening.

As a result of this construction, the cover lock mechanism according to the invention makes it possible to prevent a cover from being opened at not less than an arbitrary angle even in the case where an operator fails to do lock operation, and furthermore this cover lock mechanism can be used regardless of which direction the cover is opened in.

### EFFECT OF THE INVENTION

According to the lock mechanism of the invention, advantages can be obtained by an extremely simple construction such that the lock mechanism is held by means of a leaf spring that is mounted on the backside of a cover even if the cover is opened by itself due to any vibration during traveling the vehicle at the time of forgetting to lock the cover or being in the state of insufficient locking; as well as that a hook formed at a latch, which is biased from a center of an opening of the housing toward a periphery thereof, is hooked on the periphery of the opening due to bias force provided by the leaf spring, thus preventing the cover from being further opened and preventing the internal devices from being damaged.

### BEST MODE FOR CARRYING OUT THE INVENTION

### Embodiment 1

A cover lock mechanism according to a first preferred embodiment of the present invention is hereinafter described referring to the drawings. FIG. 1 is a cross sectional view showing a housing structure of, e.g., a control device to which cover lock mechanism according to the invention is applied. FIG. 2 is a perspective view of the backside of a cover 2 taken from inside of a hosing 1 in order to facilitate further understanding of the structure. FIG. 3 is a partially detailed view for explaining a latch of FIG. 1. FIG. 4 are explanatory views of operation at the time of closing the cover of FIG. 4. FIGS. 5 and 6 are explanatory views at the time of opening it.

The cover lock mechanism of FIG. 1 can be used in any box structure on condition that the box structure includes a door-type cover 2 that is opened and closed with respect to the housing 1 regardless of which direction the cover 2 is opened and closed in, and further, any device such as control device, electronic device, or storage cabinet of parts or documents can be contained in an internal part of the foregoing box structure. In the cover lock mechanism of FIG. 1, the housing body 1 and the cover 2 are connected so that a hinge 3 can be rotated. Although an example in which the hinge 3 is located on the upper side is described in this first embodiment, the hinge 3 may be positioned on the upper or lower side, or on the right-hand or left-hand side with respect to the cover 2. The cover 2 makes an opening 10 of the housing body 1 open or closed with the hinge 3 acting as a fulcrum.

Periphery of the cover 2 is folded toward the side of the housing 1, and this folded periphery is pressed to a packing P that is located on the inside of a packing gland 1a formed at the peripheral portion of an opening 10 when the cover 2 is closed, thereby achieving improvement in waterproof. The structure of a latch 4 of FIG. 2 is described with a partially detailed view of FIG. 3. An L-shaped leaf spring 4b is welded to the inner face of the cover 2. A latch 4 of steel plate is attached by welding 4z to the tip portion of the leaf spring 4b, and moves up and down due to elastic deformation of the leaf spring 4b. In this regard, a further description is made as to what is referred to as “up and down” herein. An example in which the latch 4 is attached to the lower side of the cover 2 is described in FIG. 1, so that moving direction of the latch 4 is up and down. However, for example, in the case where the hinge 3 is located on the left-hand side of the cover 2 and the cover is opened to the left, the latch 4 moves to the right or left side. That is, generally speaking, the latch 4 moves in a direction of connecting the center of the cover 2 and a point on a periphery of the opening 10 to which the latch 4 is attached. There is provided a run-off 4w that is cut obliquely at the rear end of the latch 4 so as to prevent the rear end of the latch 4 from being hit against the cover resulting in occurrence of a trouble when the latch 4 moves due to deformation of the leaf spring 4b. The latch 4 includes an oblique part 4x that is molded in a beveled manner at the tip portion, and a hook 4Y in the vicinity of the lower end of the oblique part 4x. In addition, a length (indicated by L) from the tip of the leaf spring 4b to the hook 4Y is a length obtained by further adding about 3 cm to 7 cm to the addition of a height of the packing gland 1a and a height of the folded part at the periphery of the cover 2.

Now, operation of the latch 4 according to the first embodiment is described.

First, the operation in the case of closing is described with reference to FIGS. 4(a) to (c).

FIG. 4 (a): The cover 2 is pressed in a direction of closing.

FIG. 4(b): The oblique part 4X of the latch 4 is interfered with the packing gland 1a of the housing 1 or with the edge of the opening 10.

FIG. 4(c): The oblique part 4X is pushed upward against the reaction force of the leaf spring to slide on the upper face of the packing gland 1a, and the latch 4 that is held with the leaf spring 4b is inserted in an internal part of the housing.

Then, a lock, not shown, is put on and the cover 2 is secured.

Next, the case where the lock 5 of the cover 2 is released (or is released by intent) and the cover 2 is opened is described with reference to FIGS. 5 and 6.

FIG. 5: When the cover 2 begins to open, the latch 4 is hooked on the edge of the opening 10 of the housing 1, and the latch 4 is opened just to an extent of a length of the latch 4. Which angle the cover 2 is hooked at is determined depending on a length (L) of the latch 4.

FIG. 6: To open the cover further, a finger is inserted through a gap with the cover 2 slightly opened, and a lower face of the latch 4 is pushed up. Then, the hook 4Y is released from the edge of the opening 10, and the cover 2 is opened unrestrainedly.

### Embodiment 2

Although there is provided a latch 4 only at one point of the cover 2 in the drawings according to the first embodiment, it is preferable to be located at two points of the cover 2 at the time of the cover 2 of a large width. To open the cover 2, respective latches 4 are pushed up at the same time with fingers of the right and left hands, thereby enabling to open it.

Further, in the drawings according to the first embodiment, the latch 4 is located on the side of the cover 2 opposite to the side on which the hinge 3 is mounted. However, a latch 4 is not always necessary to be located on this side. For example, it is preferable that the latch 4 is located on the side adjacent to the side on which the hinge is mounted. Note, however, that when a position of the latch 4 being attached is too near to the position of the hinge 3, a rotational movement at the time of opening the cover 2 may act on the latch 4, thus making it possible that anchoring the latch 4 is operated undesirably. Accordingly, the latch 4 is preferably mounted apart from the hinge 3.

### Embodiment 3

In the case of employing the latch 4 of FIG. 3, while the latch being in the state of FIG. 5, the cover 2 is opened or closed to the extent of a length L up to the hook 4Y of the latch 4 and is rattled by the movement of a vehicle, resulting in a danger of fingers being caught.

To prevent this, there is formed a notch 4R in front of the hook 4Y as shown in FIG. 6. A width of the notch 4R is slightly larger than a plate thickness at the opening 10 of the housing 1, and depth of the notch 4R is approximately a few millimeters.

In the case where the notch 4R is formed, in the state of FIG. 6 according to the first embodiment, the edge of the opening 10 is locked into the notch 4R, whereby the cover 2 is nearly secured, resulting in no fear of fingers being caught. As a matter of course, the cover is secured with the notch 4R at the time of closing the cover 2, so that the cover has to be closed by lifting it up with fingers.

### Embodiment 4

The latch 4 is made of a steel plate, and is welded to the leaf spring 4b according to the first to third embodiments, so that it takes much man-hour to manufacture it. Therefore, it is preferable to employ a plate latch 40 made of only a leaf spring as indicated by reference number 40 in FIG. 8. In this case, press-embossing a part of the leaf spring forms a part that corresponds to the notch 4R according to the third embodiment. A part that corresponds to the oblique part can be formed only by folding a leaf spring at a proper angle.

### INDUSTRIAL APPLICABILITY

The cover lock mechanism according to the present invention is not limited to the one that is mounted on a moving body, but can be applied to other fixed facilities. Furthermore, the cover lock mechanism is not necessarily limited to a cover of the housing, but can be utilized also in, for example, doors of an opening/closing hatch of wiring inspection access hole on the ceiling.

### BRIEF DESCRIPTION OF DRAWINGS

FIG. 1 is a cross sectional view of a cover lock mechanism according to a first preferred embodiment of the present invention.

FIG. 2 is an explanatory view of the backside of a cover of FIG. 1.

FIG. 3 is a partially detailed view for explaining a latch of FIG. 1.

FIG. 4 are explanatory views of operations at the time of closing the cover of FIG. 1.

FIG. 5 is an explanatory view of operation at the time of opening the cover.

FIG. 6 is an explanatory view of a method of releasing the latch for the purpose of opening the cover.

FIG. 7 is a partially detailed view of a latch of a cover lock mechanism according to a third embodiment.

FIG. 8 is a partially detailed view of a latch of a cover lock mechanism according to a fourth embodiment.

FIG. 9 is an explanatory view of external appearance of a cover.

FIG. 10 is a cross sectional view of FIG. 9.

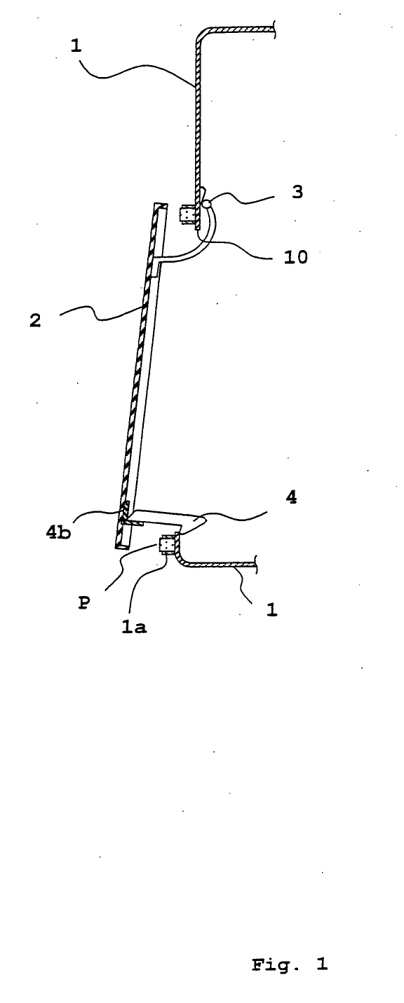

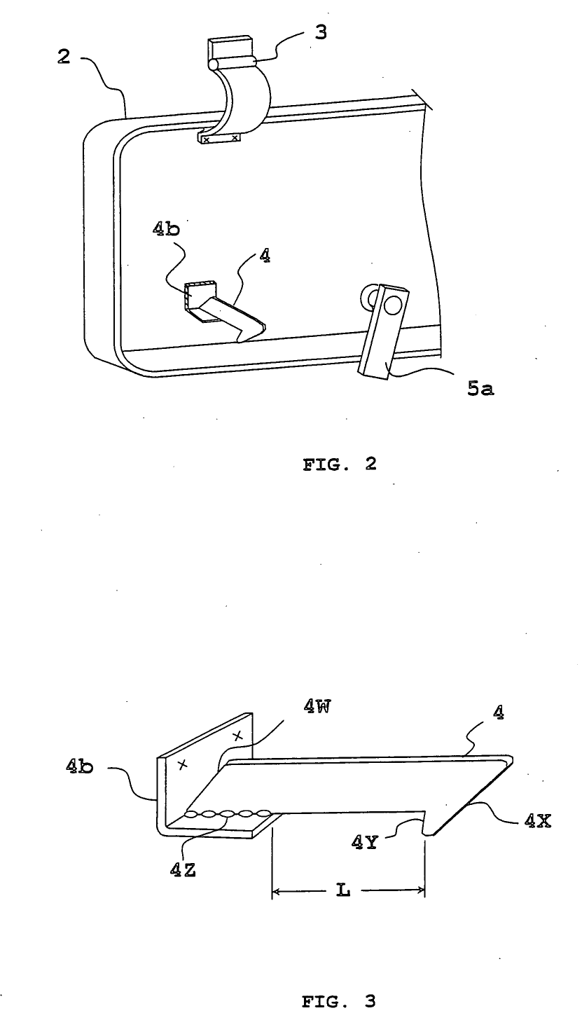

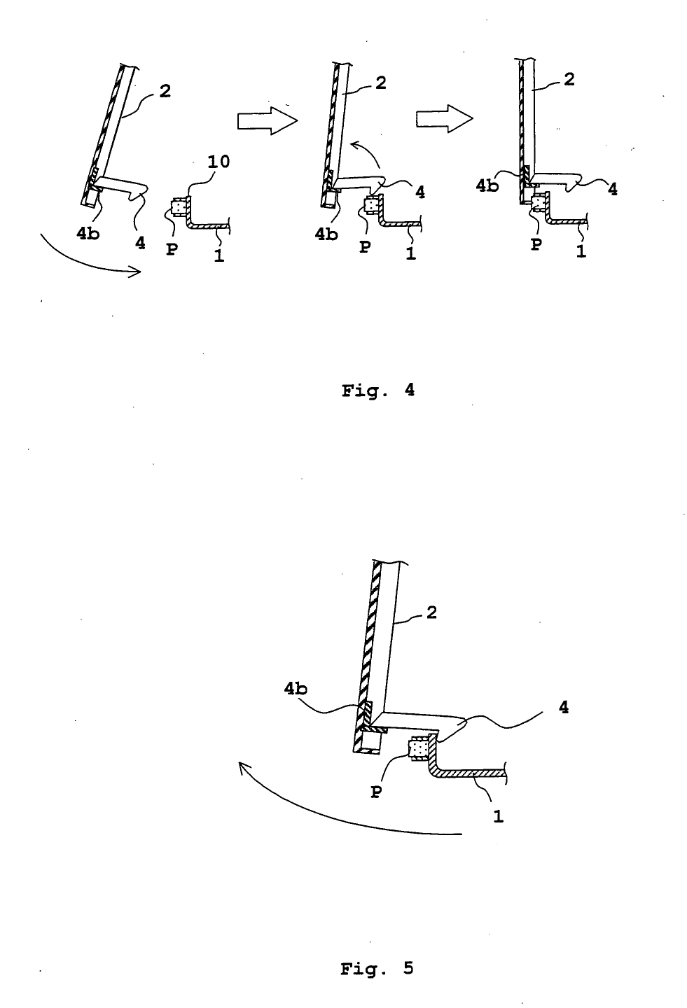

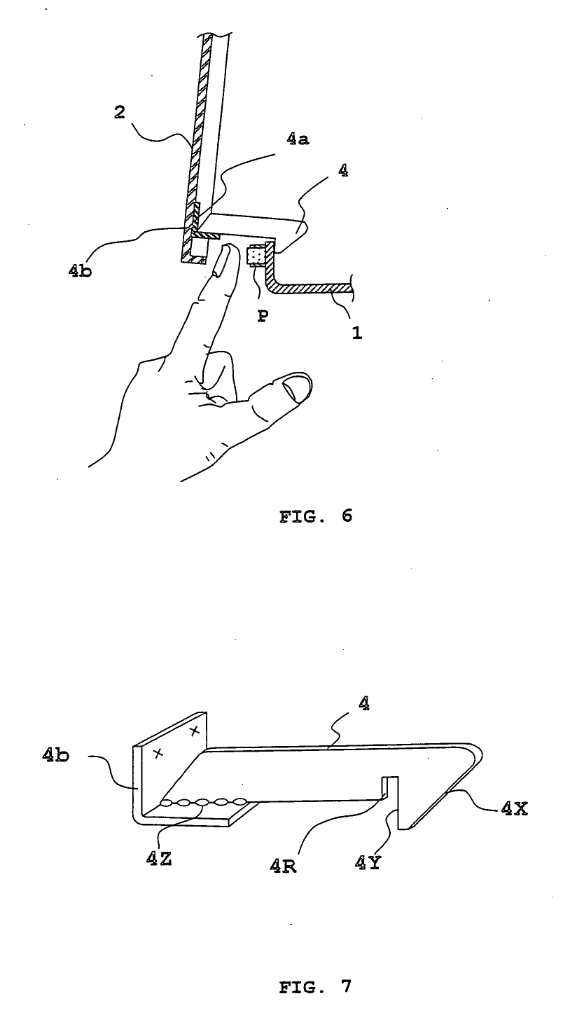

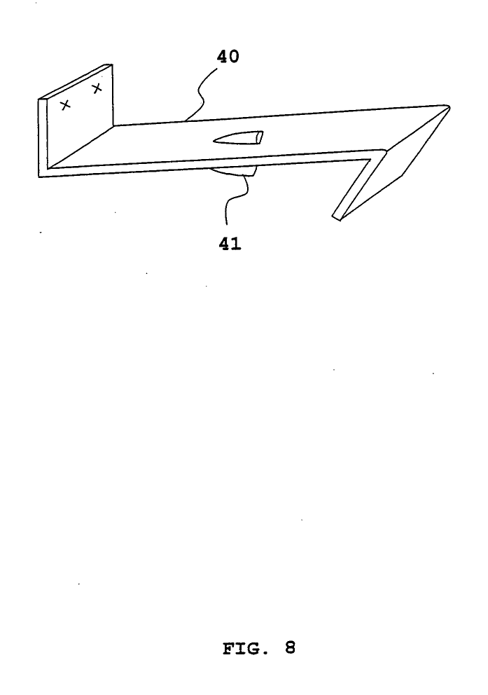

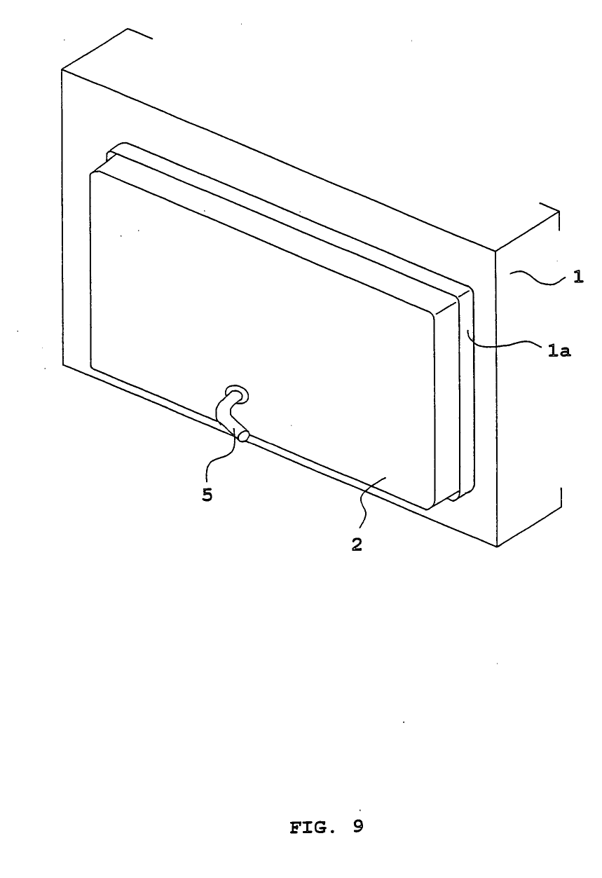

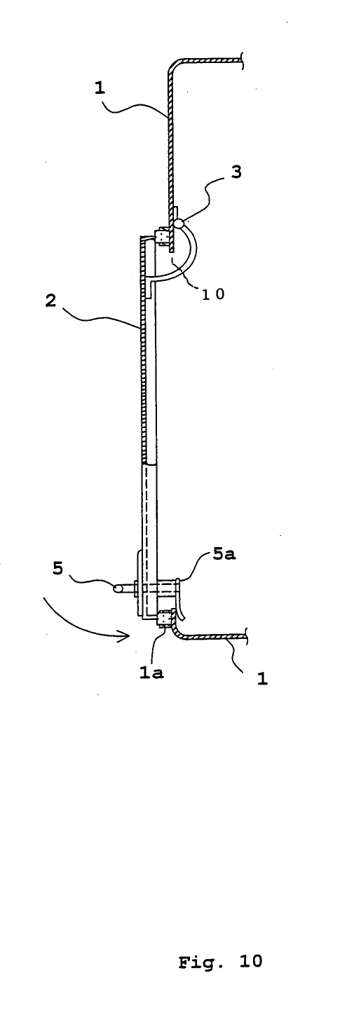

### DESCRIPTION OF REFERENCE NUMERALS

1: housing, 1a: packing gland, 2: cover, 3: hinge, 4: latch, 4a: leaf spring, 4R: notch, 4W: run-off, 4X: oblique part, 4Y: hook, 4Z: welding, 5a: pawl, 10: opening, 40: plate latch, 41: notch, P: packing

1. A cover lock mechanism comprising: a housing; a cover that is mounted rotatably with a hinge attached to said housing, and that forms an opening which causes said housing to be opened or closed; a latch that is held by means of a leaf spring mounted onto a side of said cover adjacent to said opening, and that is biased from inside of said opening toward a periphery thereof, and a hook that is formed on said latch, and that is hooked on an arbitrary point of the periphery of said opening to hold said cover to be in a state of being slightly opened when said cover is slightly opened forming a gap that allows fingers to be inserted.

2. The cover lock mechanism according to claim 1, wherein said cover comprises two latches.

3. The cover lock mechanism according to claim 1, wherein said latch comprises a notch that is formed between said hook and said cover, and holds the cover.

4. The cover lock mechanism according to claim 1, wherein said latch is manufactured by shaping a leaf spring that is mounted onto the side of said cover adjacent to said opening.
